(19) United States
(12) Patent Application Publication
(10) Pub. No.: US 2009/0212972 A1
(43) Pub. Date: Aug. 27, 2009

(54) Method for Protecting Deployed Assets in a Cooperative System

(75) Inventor: Carroll C. Kellum, Kelkheim (DE)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/035,318

(22) Filed: Feb. 21, 2008

(51) Int. Cl. G08G 1/00

(52) U.S. Cl. 340/902

(57) ABSTRACT

A communications system that includes techniques for protecting the transmission of data and information between vehicles so as to prevent a second automakers from using information developed by a first automaker. The communications system employs a layered protocol network. Sensors on the vehicle provide various information, some of which is sent to each layer in a network protocol and some of which may be broadcast. One or more encrypting algorithms is provided at suitable locations in the protocol, such as between the various layers or at the output of the sensors, that prevents data from being used by the second automaker's vehicle transmitted from the first automaker's vehicle who does not include a decryption algorithm to decrypt the information.

### BACKGROUND OF THE INVENTION

1. Field of the Invention

This invention relates generally to a system and method for protecting information transmitted between vehicles and, more particular, to a system and method for preventing third parties from using a vehicle-to-vehicle communications system for a particular purpose, such as collision avoidance, without compensating the owner of the information being transmitted or the network being used.

2. Discussion of the Related Art

Traffic accidents and roadway congestion are significant problems for vehicle travel. Vehicular ad-hoc network based active safety and driver assistance systems are known that allow a vehicle communications system to transmit messages to other vehicles in a particular area with warning messages about dangerous road conditions, driving events, accidents, etc. In these systems, multi-hop geocast routing protocols, known to those skilled in the art, are commonly used to extend the reachability of the warning messages, i.e., to deliver active messages to vehicles that may be a few kilometers away from the road condition, as a multi-hop transmission process. In other words, an initial message advising drivers of a potential hazardous road condition is transferred from vehicle to vehicle using the geocast routing protocol so that vehicles a significant distance away will receive the messages because one vehicle's transmission distance is typically relatively short. Another common method for extending the network is store and forward where one vehicle holds information for a period of time or while in a geographical area during which it is transmits the information to other vehicles that it encounters.

Vehicle-to-vehicle and vehicle-o-infrastructure applications require a minimum of one entity to send information to another entity. For example, many vehicle-to-vehicle safety applications can be executed on one vehicle by simply receiving broadcast messages from a neighboring vehicle. These messages are not directed to any specific vehicle, but are meant to be shared with a vehicle population to support the safety application. In these types of applications, where collision avoidance is desirable, as two or more vehicles talk to each other and a collision becomes probable, the vehicle systems can warn the vehicle drivers, or possibly take evasive action for the driver, such as applying the brakes. Likewise, traffic control units can observe the broadcast of information and generate statistics on traffic flow through a given intersection or roadway. Once a vehicle broadcasts a message, any consumers of the message could be unknown.

In a current standardization process for vehicle-to-infrastructure applications, standard interfaces and message definitions are defined to meet the technical objective of sharing data between multiple vehicles for multiple automakers proposed of parts from multiple suppliers. The standardization would reduce the overall development cost to automakers and suppliers and, subsequently, reduce cost to all of society.

There is a problem with open standardization data elements that involves the value of applications during deployment of the technology. Since it is a cooperative system, the benefits of many applications will only be realized when the market penetration becomes very high. For this reason, the first application sold when the market penetration is 0% will have less value than applications sold when the market penetration is 10%. However, development costs required to deploy the application will likely be higher when the penetration is 0% because the technology will be new, thus requiring extensive verification and validation of the system.

The value problem described above translates into a business risk problem during deployment. If one automaker decides to spend millions of dollars to develop the technology, this automaker may create a situation where the market penetration is near 10%. However, it might be that the application fails and that consumers are not willing to pay for it. In this case, the automaker loses significantly. Meanwhile, other automakers may never develop or deploy the application, and thus, never risk the cost associated with it. After the penetration reaches 10%, it might be that another automaker could also sell applications to consumers. If this happens, the risk to the second automaker is less because the demand already exists and there is little risk that consumers will not want the system. The reason that the second automaker can still sell an effective system is because the system will be able to utilize vehicles sold by the first automaker.

Stated in another way, the problem becomes one automaker investing in the research, development and deployment of a system where vehicles will talk to each other for various purposes without knowing whether such a system will become standard or desirable on vehicles in the future. If the system does become standard, then other automakers may be able to get into the market and use the system without the initial investment by taking advantage of the system that is already in place.

### SUMMARY OF THE INVENTION

In accordance with the teachings of the present invention, a communications system is disclosed that includes techniques for protecting the transmission of data and information between vehicles so as to prevent a second automaker from using information developed by a first automaker. In one non-limiting embodiment, the communications system employs an open system interconnection layer 7 model protocol including a physical layer, a data link layer, a network layer, a session layer, a presentation layer and an application layer. Sensors on the vehicle provide various information, some of which is sent to each layer in the protocol and some of which may be broadcast. One or more encrypting algorithm is provided at suitable locations in the protocol, such as between the various layers or at the output of the sensors, that prevents data from being used by the second automaker's vehicle transmitted from the first automaker's vehicle who does not include a decryption algorithm to decrypt the information.

Additional features of the present invention will become apparent from the following description and appended claims, taken in conjunction with the accompanying drawings.

### BRIEF DESCRIPTION OF THE DRAWINGS

FIG. 1 is a plan view of vehicles traveling down a roadway that are communicating with each other; and

FIG. 2 is a schematic block diagram of a layer protocol for a vehicle system that allows communications between vehicles in an encrypted manner, according to an embodiment of the present invention.

### DETAILED DESCRIPTION OF THE EMBODIMENTS

The following discussion of the embodiments of the invention directed to a communications system that includes techniques for protecting information transmitted between vehicles is merely exemplary in nature, and it is in no way intended to limit the invention or it's applications of uses.

As will be discussed below, the present invention proposes a method that can be used to prevent a second automaker from using information broadcast from vehicles sold by a first automaker in a vehicle-to-vehicle or vehicle-to-infrastructure communications system. In order to use the information from the vehicles sold by the first automaker, the second automaker would have to know an algorithm that allows it to decrypt information transmitted from the first automaker's vehicles. Also, for the second automaker to use functionality, such as packet forwarding, using vehicles sold by the first automaker, the second automaker may have to supply a piece of information generated by an algorithm supplied by the first automaker. In this way, a second automaker must include an algorithm provided by the first automaker. The present invention gives the second automaker control over who is able to use data and functionality from the first automaker's vehicles.

From a business perspective, the present invention can protect the investment made by an automaker by increasing the risks for automakers to deploy technology. The present invention also allows the first automaker to better protect the integrity of the information sent from its vehicles. It is noted that the use of the terms first automaker and second automaker herein does not imply that the first automaker is the first automaker to market with a particular communications system and the second automaker is the second to market with a particular communications system. These terms are also inclusive of a second to market automaker being the first automaker and a first to market automaker being the second automaker where, for example, the first to market automaker has a high-cost and low market share communications system, and the second to market automaker has a low-cost and high market share communications system.

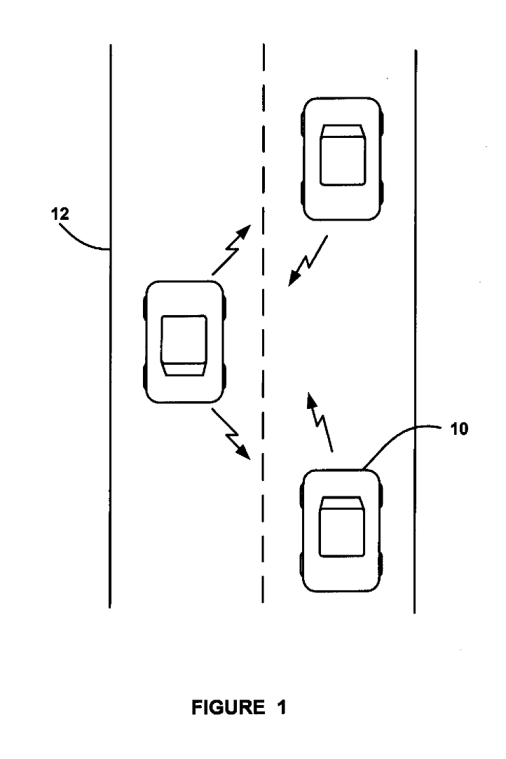

FIG. 1 is a plan view of vehicles 10 traveling along a roadway 12. The vehicles 10 include a communications system of the type discussed above where the vehicles 10 can talk to each other over a suitable transmission network of the types known in the art. There are many benefits that vehicles will have by communicating with each other. One of those benefits would be collision avoidance where information about the vehicle speed, direction, position, etc. can be broadcast to the other vehicles. Systems that employ sensors and communications devices that provide such information are known to those skilled in the art. Although the discussion herein is for communications between the vehicles 10. In an alternate embodiment, the present invention also contemplates communications between a vehicle 10 and some type of road side or other unit. Further, the discussion herein includes information obtained by sensors on the vehicles 10. This sensor information can be used to generate a new type of information, such as a slippery road at a certain location.

Obviously, each vehicle 10 will need to have the communications system necessary to communicate with the other vehicles 10 in order for a particular vehicle to benefit from the system. An automaker that went through the expense of developing such a system to put it on its vehicles will not realize the benefit of such a system until enough vehicles include the system. Once a critical mass of vehicles employing the system has been reached, then other automakers could benefit by putting the system on their vehicles to be incorporated with the already existing communications network. However, the second automaker did not have to go through the expense of developing the system and then putting it on its vehicles before it has been tested and assured to be a commercial success. Thus, the present invention allows the originating automaker to protect the transmission of information sent between the vehicles 10 so that other automakers can not benefit from the information once the system has been commercialized and successful without compensating the first automaker. Not only does the present invention propose protecting existing information sent between the vehicles 10, but also contemplates protecting information and applications that may subsequently be developed in the future. The future information and applications may be deployed on an existing fleet based on an existing design or on newly developed vehicles.

The present invention proposes providing special encryption and decryption algorithms throughout the protocols used in these types of communications systems. For example, one known communications system description is referred to as the open system interconnection (OSI) 7 layer model that identifies and defines protocols at different layers of the communications system. The OSI 7 layer model is well understood to those skilled in the art.

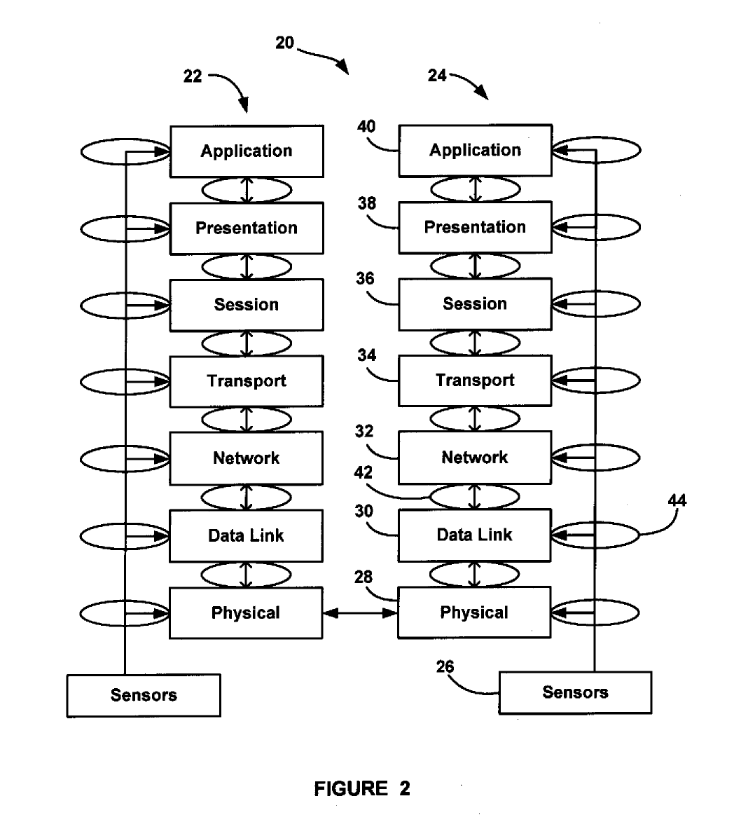

FIG. 2 is a schematic block diagram depicting a communications system 20 including an OSI 7 layer protocol model 22 on one vehicle and an OSI 7 layer protocol model 24 on another vehicle, where the protocol models are part of a network. The vehicles will include various sensors 26 for providing vehicle information, such as vehicle speed, direction, position, yaw rate, etc. The OSI protocol models 22 and 24 include a physical layer 28, a data link layer 30, a network layer 32, a transport layer 34, a session layer 36, a presentation layer 38 and an application layer 40. The physical layer 28 allows one system to talk to another system through cabling, wireless connections, optical connections, etc. It is at this protocol level that the vehicles talk to each other where the physical layer 28 of the OSI layer model 22 can talk to the physical layer 28 of the OSI 7 layer model 24. Thus, the information from the sensors 26 on one vehicle can be transmitted to the layer model on another vehicle. Further, at least some of the sensor information from the sensors 26 is generally used by each of the protocol layers 28-40 in the vehicle that includes the sensors 26. Data that is transmitted back and forth between the models 22 and 24 goes up and down through the protocol layers 28-40 depending on what information is being transmitted, and what actions need to be taken.

According to certain embodiments of the invention, the transmission of data and information between the vehicles 10 is protected by selectively encrypting the data and information at various locations in the communications network. This prevents vehicles that do not have the decryption algorithm from using the information. The information sent by the physical layer 28 from the sensors 26 can first be sent to an encrypting algorithm 44 that encrypts the data prior to the data being received transmitted to the other vehicles and subsequently the protocol layers 28-40. Likewise, the transfer of data and other information between the OSI models 22 and 24 can be sent through an encrypting algorithm 42. Therefore, the transfer of data through the network in the vehicle must be decrypted after the encryption in order for it to be used by the protocol. Many types of encrypting algorithms are known to those skilled in the art that would be suitable for the purposes discussed herein. Suitable examples may include RSA, data encryption standard (DES), triple-DES, blowfish, international data encryption algorithm (IDEA), software-optimized encryption algorithm (SEAL) and RC4.

The most basic location for providing encryption is between the physical layer 28 and the data link layer 30 Data and information that is going to be transmitted by the physical layer 28 and is received from the data link layer 30 is encrypted before it is sent to the physical layer 28, and thus is encrypted when it is received by the physical layer 28 of another vehicle. Here information remains unaffected until the moment the information is broadcast through a wireless medium. In this way, other nodes in the area would receive completely encrypted information that would be difficult to use. At this layer, the most amount of information will have to be encrypted, which may require more computer resources. However, it may also be that this location is the best location for encryption because the algorithm used could be implemented on a computing platform specifically designed for modifying all information.

As the data information to be transmitted moves down through the layers from the application layer 40 to be transmitted at the physical layer 28, or sensor information is to be transmitted by the physical layer 28, the data can be encrypted at any desirable location between the layers. If the opportunity for encryption is moved up through the layers 28-40, the amount of information that would require encryption reduces, which may reduce the amount of computing power required for encryption and decryption algorithms. Also, as the locations for encryption/decryption moves up through the layers 2840, more control is provided as to what information can be encrypted. For example, implementation between the presentation layer 38 and the application layer 40 might allow some applications or instances of applications to use the encryption or others may not. Also, it may be that pieces of information are encrypted, such as vehicle speed, vehicle heading or vehicle position. Encrypting the smaller pieces of information may reduce the amount of computing required for encryption, but allows others to use standard interfaces to decode the remaining data.

The present invention recognizes that different elements and applications could use different types of encryption schemes, or could simply use different keys with the same encryption scheme. In this way, the system will allow manufacturers to allow others to decode certain types of information, but not those that do not have the keys. For example, a broadcasted message may contain forty different data elements. A manufacturer could use a different key for each data element to encrypt the data. The manufacturer could allow any number of other manufacturers to use one of the forty keys. This would allow other manufacturers to decrypt one data element while keeping the other thirty-nine data elements hidden and unusable.

Similarly, encryption of the information could be applied on certain messages rather than data elements. The encryption scheme of the invention could also be applied to certain functionality. For example, if a node from another manufacturer requests forwarding of a packet via a node utilizing the encryption of the invention, the other node may have to supply a piece of information that confirms that it has the right to forward the request. One way to do this is to add a data element to the original packet. The data element could consist of some combination of data from the original packet. When the node containing the encryption receives the data, it will try to recreate the added data element from the other data elements in the packet. If the created data element matches the data element sent, a node may forward the packet as requested. The way in which the data is confined in an encryption scheme can be selectively provided by any suitable technique.

In the end, the most likely encryption technology for this application is symmetric key algorithms that utilize a shared secret between the nodes. It could be that all vehicles sold from an automaker use the same algorithm and are programmed with the same key. This algorithm and key are the shared secret. It could also be that the algorithm is the shared secret or only that the key is the shared secret.

The present invention also contemplates asymmetric cryptography using public and private keys for protecting the information where encrypting information sent between at least two layers in the protocol could include providing an encryption algorithm where the algorithm and the private key need to be known by the vehicle receiving the information. Alternately, the encrypted information can be a digital signature allowing the vehicle receiving the information to authenticate the identity of the sender with a public key that corresponds to a private key used by the sender.

If the encryption is broken at some point in time legal protection should still exist making it illegal for others to decode the information without authorization. For this reason, it may be required that the automaker using the technology retains ownership, or possibly copyrights, of the information sent from the vehicles. If this is done, anyone requiring access to the information will have to contact the automaker instead of individual vehicles owners. The invention is not limited to the use of vehicles and can be extended to various types of wireless networks of mobile and non-mobile nodes. For instance, pedestrians can carry devices that share information between them. Additionally, networks that are formed somewhat randomly by distributing communicating nodes from aircraft or watercraft could also benefit from the invention.

The invention generally can be described as a method for protecting the use of a wireless network composed largely of mobile nodes, where each node employs a network protocol. The method requires that a requesting node prove that it is a valid member of the network before any other node will provide certain network functions to the requesting node, where proving valid membership can include employing a digital signature that allows nodes that receive the information to verify the identity of the node sending the information with a public key that corresponds to a private key used by the sending node. The certain network functions can include multi-hopping information, forwarding information, geo-casting information or storing and forwarding information.

The foregoing discussion discloses and describes merely exemplary embodiments of the present invention. For example, although the foregoing detailed description is provided in the context of automobile communications, it is equally applicable to communications between other types of devices without departing from the scope of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for protecting the wireless transmission of information between nodes, each node employing a communications protocol including a plurality of protocol layers, said method comprising:
providing sensors on the nodes that are used to provide node information;
providing the node information to at least one of the layers in the protocol for that node; and
encrypting information sent between at least two layers in the protocol that includes node information that is to be sent to other nodes so that a node will need to decrypt the information sent to it from another node.

2. The method according to claim 1 wherein one of the nodes is a stationary node.

3. The method according to claim 1 wherein one of the nodes is a mobile node.

4. The method according to claim 1 wherein providing the node information to at least one of the layers in the protocol includes providing at least some of the node information to every layer in the protocol.

5. The method according to claim 1 wherein encrypting information sent between at least two layers in the protocol includes encrypting information between every adjacent two layers in the protocol.

6. The method according to claim 5 wherein the amount of information required to be encrypted is reduced as information is transferred to higher layers from a physical layer.

7. The method according to claim 1 wherein each node employs an open system interconnection layer 7 model protocol including a physical layer, a data link layer, a network layer, a session layer, a presentation layer and an application layer.

8. The method according to claim 7 wherein encrypting information sent between at least two layers includes encrypting information sent between the physical layer and the data link layer.

9. The method according to claim 1 wherein providing sensors on the node that are used to provide node information includes providing sensors that provide node location, node heading, node speed and node yaw rate.

10. The method according to claim 1 wherein providing sensors on the nodes includes providing information collected from a distributed set of nodes.

11. The method according to claim i wherein encrypting information sent between at least two layers in the protocol includes encrypting information related to messages.

12. The method according to claim 1 wherein encrypting information sent between at least two layers in the protocol includes encrypting information related to data elements.

13. The method according to claim 1 wherein encrypting information sent between at least two layers in the protocol includes providing a symmetric encryption algorithm and a key that need to be known by the other nodes receiving the node information.

14. The method according to claim 1 wherein encrypting information sent between at least two layers in the protocol includes providing an asymmetric encryption algorithm and a key where the algorithm and the key need to be known by the node receiving the information.

15. The method according to claim 1 wherein encrypting information sent between at least two layers in the protocol includes employing a digital signature that allows nodes that receive the node information to authenticate the identity of the node sending the information with a public key that corresponds to a private key used by the sending node.

16. The method according to claim 1 wherein the node and a second node are made by two different manufacturers.

17. A method for protecting information transmitted between nodes, said method comprising:
providing sensors on the nodes that are used to provide node information;
providing the node information to a network protocol for that node;
broadcasting the node information from one node to other nodes; and
encrypting the node information broadcast from the one node so that the other nodes will need to decrypt the information sent to it from the one node using decrypting information from a manufacturer of the one node before it can use the information.

18. The method according to claim 17 wherein the network protocol is an open system interconnection layer 7 model protocol including a physical layer, a data link layer, a network layer, a session layer, a presentation layer and an application layer.

19. The method according to claim 18 wherein the node information is encrypted between the physical layer and the data link layer in the node that is broadcasting the node information.

20. The method according to claim 17 wherein the node information from the sensors is encrypted before it is provided to the network protocol.

21. The method according to claim 17 wherein providing sensors on the node that provide node information includes providing sensors that provide node location, node heading, node speed and node yaw rate.

22. The method according to claim 21 wherein providing sensors on the nodes includes providing information collected from a distributed set of nodes.

23. The method according to claim 17 wherein encrypting information sent between at least two layers in the protocol includes encrypting information related to messages.

24. The method according to claim 17 wherein encrypting information sent between at least two layers in the protocol includes encrypting information related to data elements.

25. The method according to claim 17 wherein encrypting information sent between at least two layers in the protocol includes providing a symmetric encryption algorithm and a key that need to be known by the other nodes receiving the node information.

26. The method according to claim 17 wherein encrypting information sent between at least two layers in the protocol includes providing an asymmetric encryption algorithm and a key where the algorithm and the key need to be known by the node receiving the information.

27. The method according to claim 17 wherein encrypting information sent between at least two layers in the protocol includes employing a digital signature that allows nodes that receive the node information to authenticate the identity of the node sending the information with a public key that corresponds to a private key used by the sending node.

28. The method according to claim 17 wherein the one node and the other nodes are made by different manufacturers.

29. A method for protecting the transmission of information between nodes, each vehicle employing an open system interconnection layer 7 model protocol including a physical layer, a data link layer, a network layer, a session layer, a presentation layer and an application layer, said method comprising:
providing sensors on the nodes that are used to provide node information including node location, node heading, node speed and node yaw rate;
providing the node information to at least one of the layers in the protocol for that node; and
encrypting information sent between at least two layers in the protocol that includes node information that is to be sent to other nodes so that a node will need to decrypt the information sent to it from another node, wherein encrypting information sent between at least two layers in the protocol includes providing an encryption algorithm that has a key where the algorithm and key need to be known by the node receiving the information, and wherein encrypting information sent between at least two layers includes encrypting information sent between the physical layer and the data link layer.

30. The method according to claim 29 wherein providing the node information to at least one of the layers in the protocol includes providing at least some of the node information to every layer in the protocol.

31. A method for protecting the use of a wireless network composed largely of mobile nodes, each node employing a network protocol, said method comprising:
requiring that a requesting node prove that it is a valid member of the network before any other node will provide certain network functions to the requesting node.

32. The method according to claim 31 wherein proving valid membership includes employing a digital signature that allows nodes that receive the information to verify the identity of the node sending the information with a public key that corresponds to a private key used by the sending node.

33. The method according to claim 31 where the certain network functions include multi-hopping information, forwarding information, geo-casting information or storing and forwarding information.
